(19) United States
(12) Patent Application Publication
(10) Pub. No.: US 2011/0213714 A1
(43) Pub. Date: Sep. 1, 2011

(54) SERVICE PROVIDER IDENTIFIERS

(75) Inventors: Joanne Saiu, San Jose, CA (US); Puma Prasad Maddukuri, San Ramon, CA (US); Shanti Muppirala, San Jose, CA (US); Tamijselvy Muralidharan, San Jose, CA (US); Marc Cagigas, Castro Valley, CA (US); June Yee, Orinda, CA (US)

(73) Assignee: Oracle International Corporation, Redwood Shores, CA (US)

(21) Appl. No.: 12/713,382

(22) Filed: Feb. 26, 2010

(51) Int. Cl. G06Q 10/00

(52) U.S. Cl. 705/301

(57) ABSTRACT

Embodiments of the invention provide systems and methods for determining whether a service provider submitted for a new assignment has been previously identified as eligible or ineligible for new assignments. According to one embodiment, a method of determining eligibility of a candidate service provider for a new assignment can comprise defining a set of identifiers for information related to a plurality of service providers. A set of records of service provider information can be maintained where each record of the set of records includes information corresponding to the set of identifiers. Information for the candidate service provider can be received and validated based on the set of identifiers and the set of records of service provider information to determine whether the candidate service provider is eligible for the new assignment.

### BACKGROUND OF THE INVENTION

Embodiments of the present invention relate generally to methods and systems for managing service providers and more particularly to determining whether a service provider submitted for a new assignment has been previously identified as eligible or ineligible for new assignments.

Businesses in a wide variety of industries commonly rely on contract, contingent, or other temporary workers or service providers to perform various tasks in place of or in addition to regular employees. When selecting a candidate service provider, there are times when an enterprise may want to prevent selection of a particular individual for new assignments. This situation could occur as a result of performance on a previous assignment so unacceptable that the business feels compelled to take steps to ensure that the individual is not brought in again for a new assignment. It could also occur as a result of previous background checks or other information obtained prior to ever accepting the service provider for an initial assignment.

To perform such checks, service providers or contingent workers need to be uniquely identified by services procurement applications that may be used to manage, for example, service provider intake or on-boarding processes. However, name alone is not enough to identify and distinguish service providers with certainty since multiple people can have the same or similar names. This is even more of an issue when a different supplier submits the ineligible service provider. In this case, a different user ID may have been created and any existing timesheet ratings or survey results associated to the other user ID would not be recognized as being for the same person. Additionally, users of these applications have different policies as to what information can be retained for a service provider, so the addition of social security number or similar types of identification to the user information would be an issue or even prohibited by some users. Thus, current service procurement applications do not capture information to identify a service provider other than their name. Also, there was no comparison against known ineligible service providers prior to extending an offer of creating a manual work order. Hence, there is a need for improved methods and systems for determining whether a service provider submitted for a new assignment has been previously identified as eligible or ineligible for new assignments.

### BRIEF SUMMARY OF THE INVENTION

Embodiments of the invention provide systems and methods for determining whether a service provider submitted for a new assignment has been previously identified as eligible or ineligible for new assignments. According to one embodiment, a method of determining eligibility of a candidate service provider for a new assignment can comprise defining a set of identifiers for information related to a plurality of service providers. A set of records of service provider information can be maintained where each record of the set of records includes information corresponding to the set of identifiers. Additionally, each record of the set of records of service provider information can include a field for an indication of eligibility or ineligibility. Information for the candidate service provider can be received. Receiving the information for the candidate service provider can comprise receiving the information for the candidate service provider via a bidding process or via a work order process. In either case, the information for the candidate service provider can be validated based on the set of identifiers and the set of records of service provider information to determine whether the candidate service provider is eligible for the new assignment.

Validating the received information for the candidate service provider can comprise selecting information from the received information for the candidate service provider based on the set of identifiers and searching the set of records of service provider information for information matching the selected information from the received information for the candidate service provider. In response to finding a perfect match between the selected information from the received information for the candidate service provider and a record of the set of records of service provider information, a determination can be made as to whether the candidate service provider is eligible based on the indication of eligibility for the matching record. In response to determining the candidate service provider is ineligible, the candidate service provider can be blocked from the new assignment. In response to finding a partial match between the selected information from the received information for the candidate service provider and a record of the set of records of service provider information, the service provider information from the matching record can be displayed. An update of the service provider information for the received information for the candidate service provider can be received and saved. For example, the update of the service provider information for the received information for the candidate service provider can include an indication of eligibility or ineligibility.

According to another embodiment, a system can comprise a repository of service provider identifiers having stored therein a set of identifiers for information related to a plurality of service providers and a repository of service provider information having stored therein a set of records of service provider information. Each record of the set of records can include information corresponding to the set of identifiers. The system can also include a Supplier Relationship Management (SRM) system communicatively coupled with the repository of service provider identifiers and the repository of service provider information. The SRM system can receive information for a candidate service provider and validate the received information for the candidate service provider based on the set of identifiers and the set of records of service provider information to determine whether the candidate service provider is eligible for a new assignment.

Validating the received information for the candidate service provider can comprise selecting information from the received information for the candidate service provider based on the set of identifiers and searching the set of records of service provider information for information matching the selected information from the received information for the candidate service provider. The SRM system, in response to finding a perfect match between the selected information from the received information for the candidate service provider and a record of the set of records of service provider information, can determine whether the candidate service provider is eligible based on an indication of eligibility from the matching record. In response to finding a partial match between the selected information from the received information for the candidate service provider and a record of the set of records of service provider information, the SRM system can display the service provider information from the matching record. The SRM system can further receive an update of the service provider information for the received information for the candidate service provider and save the update of the service provider information for the received information for the candidate service provider. For example, the update of the service provider information for the received information for the candidate service provider can include an indication of eligibility or ineligibility.

According to yet another embodiment, a machine-readable medium can have stored therein a series of executable instructions which, when executed by a processor, cause the processor to determine eligibility of a candidate service provider for a new assignment by defining with a Supplier Relationship Management (SRM) system a set of identifiers for information related to a plurality of service providers. A set of records of service provider information can be maintained with the SRM system where each record of the set of records includes information corresponding to the set of identifiers. Additionally, each record of the set of records of service provider information can include a field for an indication of eligibility or ineligibility. Information for the candidate service provider can be received by the SRM system. The information for the candidate service provider can be validated with the SRM system based on the set of identifiers and the set of records of service provider information to determine whether the candidate service provider is eligible for the new assignment.

Validating the received information for the candidate service provider can comprise selecting information from the received information for the candidate service provider based on the set of identifiers and searching the set of records of service provider information for information matching the selected information from the received information for the candidate service provider. In response to finding a perfect match between the selected information from the received information for the candidate service provider and a record of the set of records of service provider information, a determination can be made as to whether the candidate service provider is eligible based on the indication of eligibility for the matching record. In response to determining the candidate service provider is ineligible, the candidate service provider can be blocked from the new assignment. In response to finding a partial match between the selected information from the received information for the candidate service provider and a record of the set of records of service provider information, the service provider information from the matching record can be displayed. An update of the service provider information for the received information for the candidate service provider can be received and saved. For example, the update of the service provider information for the received information for the candidate service provider can include an indication of eligibility or ineligibility.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for maintaining service provider information and determining service provider eligibility according to one embodiment of the present invention.

FIG. 4 is a flowchart illustrating a process for maintaining service provider information and determining service provider eligibility according to one embodiment of the present invention.

FIG. 5 is a screenshot illustrating an exemplary user interface for service provider identifier definition according to one embodiment of the present invention.

FIGS. 6A and 6B are screenshots illustrating exemplary user interfaces for service provider information maintenance according to one embodiment of the present invention.

FIGS. 7A and 7B are screenshots illustrating exemplary user interfaces for submitting service provider information under a bidding process according to one embodiment of the present invention.

FIG. 8 is a screenshot illustrating an exemplary user interface for submitting service provider information under a work order process according to one embodiment of the present invention.

FIG. 9 is a flowchart illustrating a process for validating service provider information according to one embodiment of the present invention.

FIGS. 10A and 10B are screenshots illustrating exemplary user interfaces for providing validation warnings according to one embodiment of the present invention.

FIGS. 11A and 11B are screenshots illustrating exemplary user interfaces for providing validation warnings according to another embodiment of the present invention.

FIG. 12 is a screenshot illustrating an exemplary user interface for reviewing service provider information according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for determining whether a service provider submitted for a new assignment has been previously identified as eligible or ineligible for new assignments. More specifically, embodiments of the present invention provide for identifying service providers who should not be used again and recognize attempts to submit that service provider or a service provider with similar identifying information in the future. According to one embodiment, a set of identifiers can be defined which indicate which information related to the candidate service provider will be used to validate the candidate service provider. The indicated information for the candidate service provider can then be used to search against a set of records for a plurality of service providers, e.g., previously known service providers for which information has been saved. When a potential match is recognized based on the defined identifiers and maintained service provider information, a warning can be issued and the user, e.g., coordinator or administrator, given an opportunity to determine whether it is an actual match or not and/or update the service provider information, e.g., provide an indication of eligibility or ineligibility.

Stated another way, determining eligibility of a candidate service provider for a new assignment can comprise defining a set of identifiers for information related to a plurality of service providers. A set of records of service provider information can be maintained where each record of the set of records includes information corresponding to the set of identifiers. Information for the candidate service provider can be received and validated based on the set of identifiers and the set of records of service provider information to determine whether the candidate service provider is eligible for the new assignment. Various additional details of embodiments of the present invention will be described below with reference to the figures.

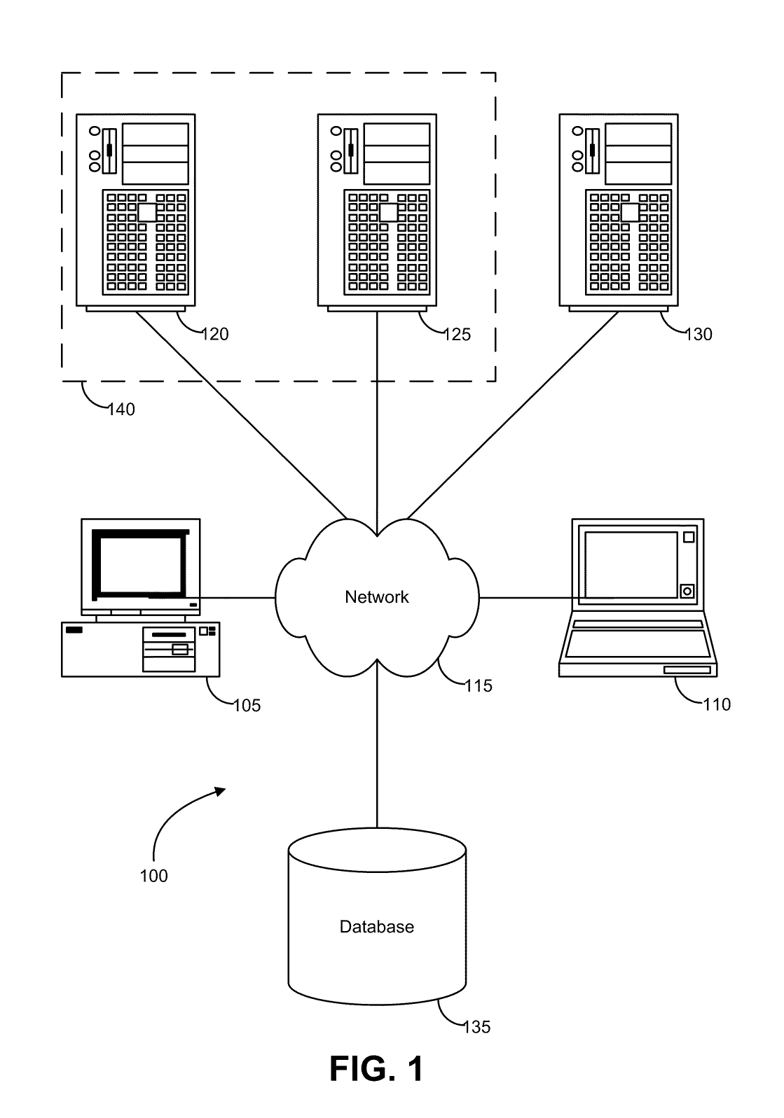

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network can be any type of network familiar to those skilled in the art that can support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

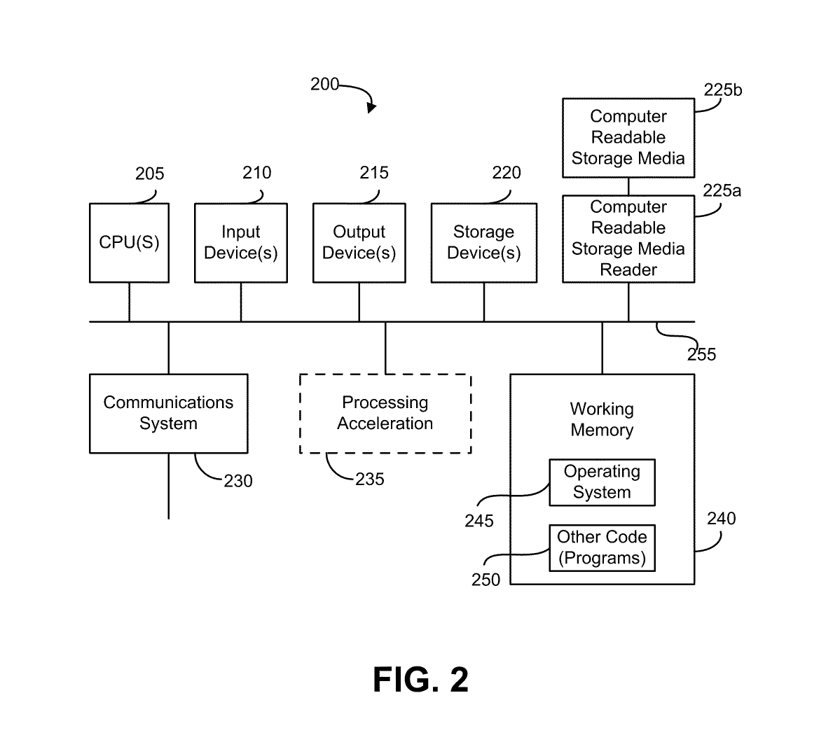

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

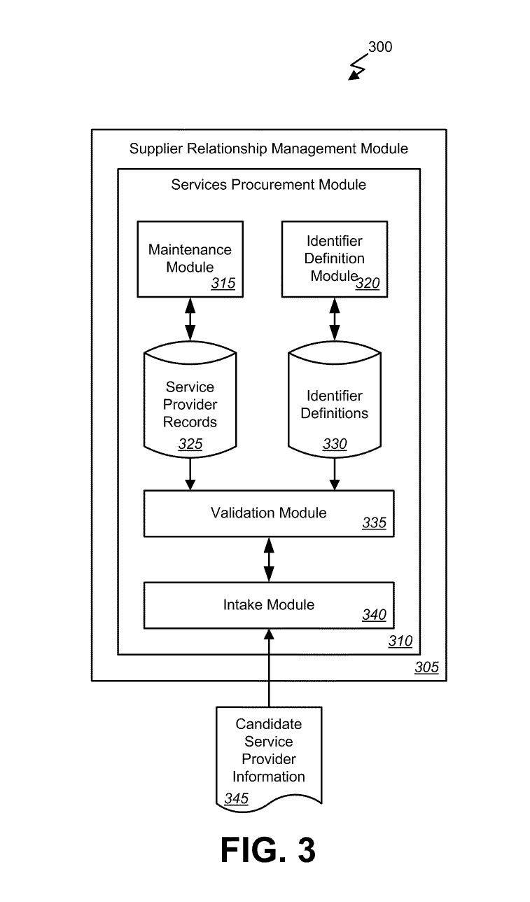

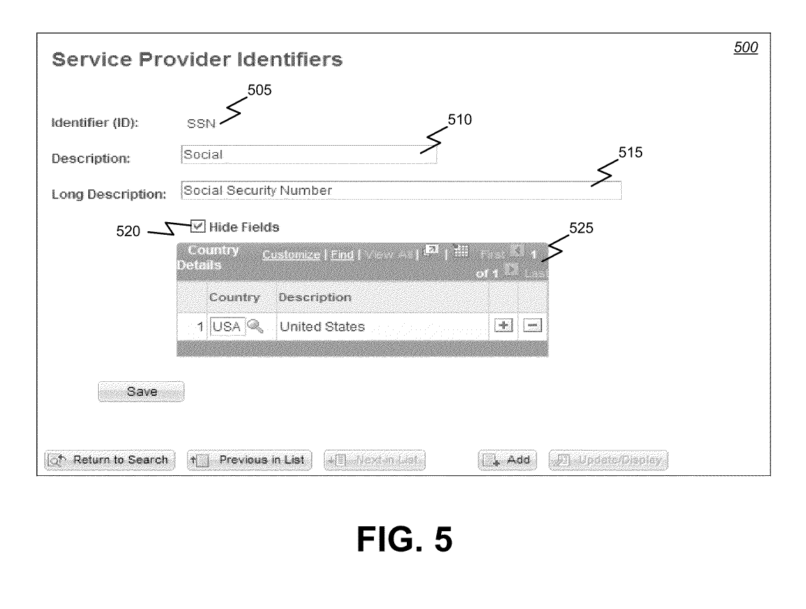

FIG. 3 is a block diagram illustrating, at a high-level, functional components of a system for maintaining service provider information and determining service provider eligibility according to one embodiment of the present invention. In this example, the system 300 can include a Supplier Relationship Management (SRM) module 305 or system as may be part of an enterprise solution executed on a client or server as described above. The SRM module 305 or system can include a services procurement module 310 that can be adapted to perform various aspects of the present invention. For example, the services procurement module 310 can include an identifier definition module 320 that can be used to define a set of identifiers for information related to service providers. For example, the identifier definition module 320 can provide a user interface such as illustrated in and described in detail below with reference to FIG. 5 through which a set of identifiers can be defined which indicate which information related to the candidate service provider will be used to validate the candidate service provider.

The identifier definition module 330 can be communicatively coupled with a repository 330 in which the identifier definitions can be stored. It should be noted that while illustrated here as part of or within the SRM module 310, such an arrangement is not required. Rather, the repository of identifier definitions 330 may be external to yet accessible by the SRM module 310. Any such variations in implementation are considered to be within the scope of the present invention.

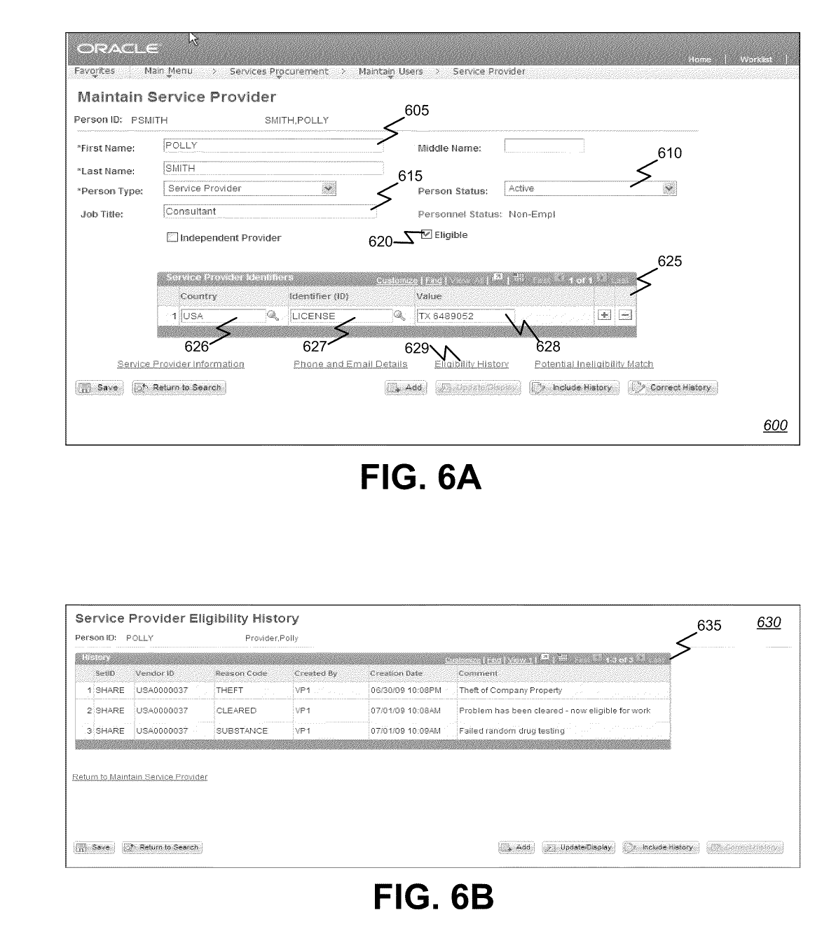

The SRM module 310 can also include a maintenance module 315. The maintenance module 315 can be communicatively coupled with a repository 325 in which service provider information can be stored. It should be noted that while illustrated here as part of or within the SRM module 310, such an arrangement is not required. Rather, the repository of service provider information 325 may be external to yet accessible by the SRM module 310. Any such variations in implementation are considered to be within the scope of the present invention. Regardless of the exact implementation, the maintenance module 315 can be adapted to define and/or maintain records of service provider information in the repository of service provider records 325. For example, the maintenance module 315 can provide a user interface such as illustrated and described in detail below with reference to FIGS. 6A and 6B through which service provider information records can be defined and/or edited.

As noted above, embodiments of the invention provide for determining whether a service provider submitted for a new assignment has been previously identified as eligible or ineligible for new assignments. More specifically, embodiments of the present invention provide for identifying service providers who should not be used again and recognize attempts to submit that service provider or a service provider with similar identifying information in the future. According to one embodiment, identifier definitions 330 can be defined, e.g., through identifier definition module 320, which indicate which information related to a candidate service provider will be used to validate the candidate service provider.

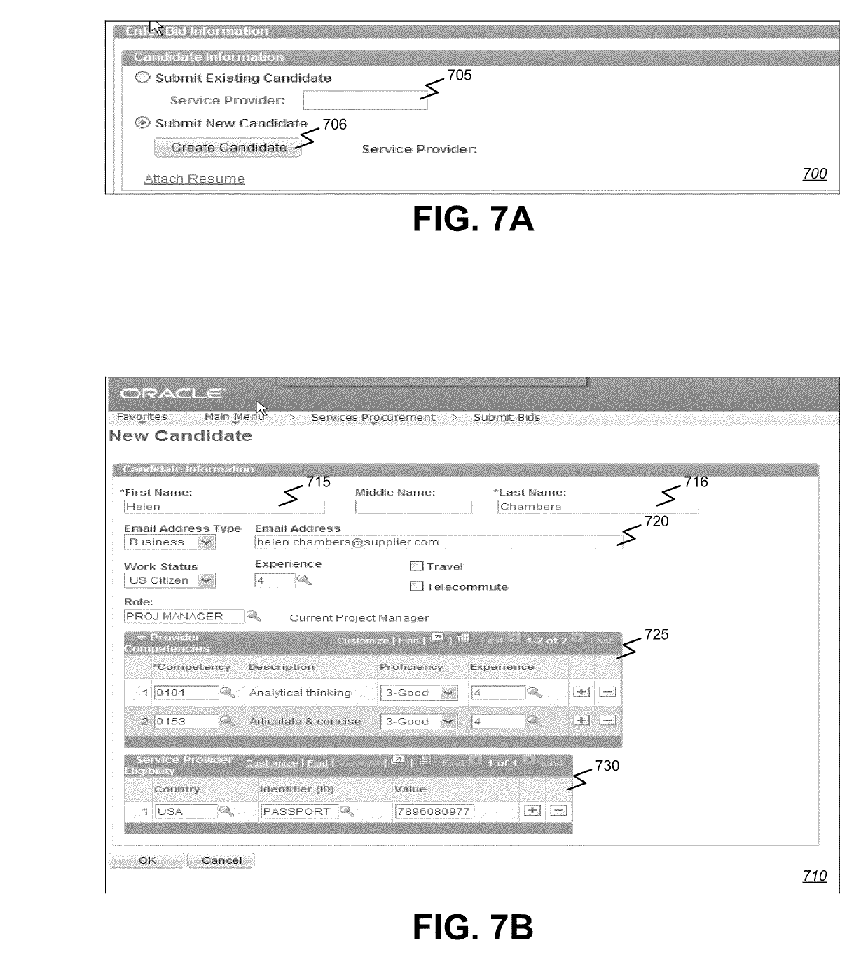

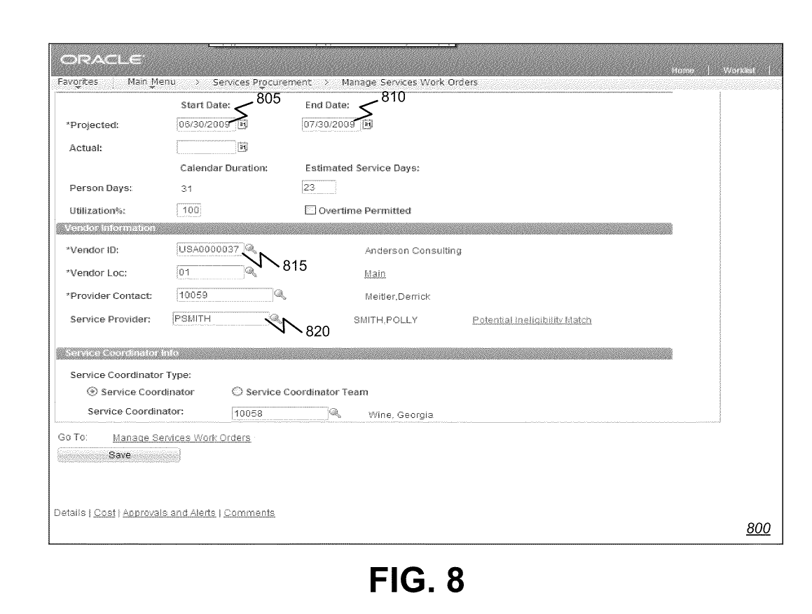

Information for the candidate service provider 345 can be received at the SRM system 305, for example, via intake module 340. According to one embodiment, the candidate information 345 can be received through a bidding process. For example, the intake module 340 can be a manually selected provider or a bidding process with a user interface such as illustrated in and described in detail below with reference to FIGS. 7A and 7B through which candidate information can be submitted. Additionally or alternatively, the candidate information 345 can be received through a work order process. For example, the intake module 340 can provide a work order process with a user interface such as illustrated in and described in detail below with reference to FIG. 8 through which candidate information can be submitted.

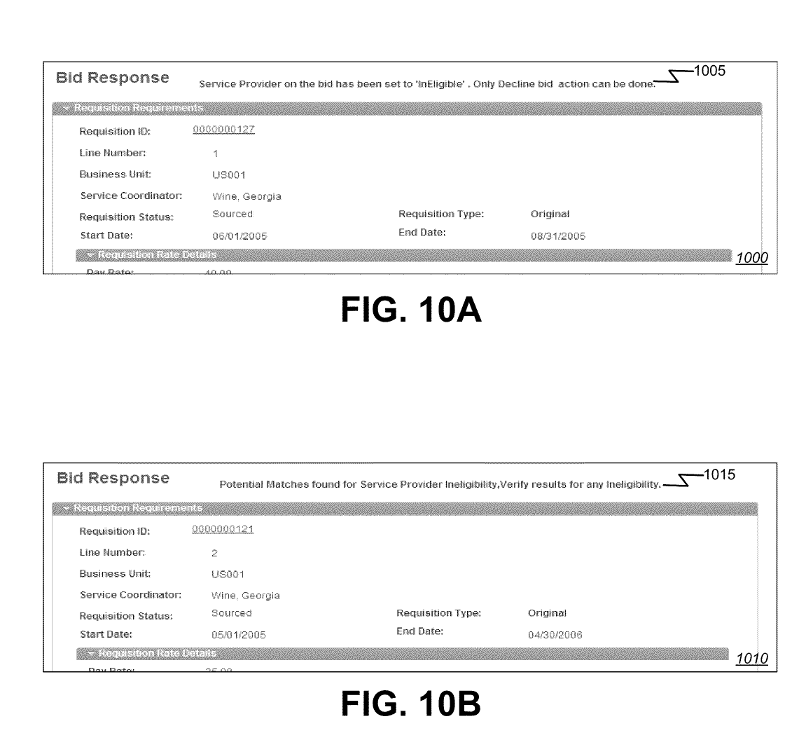

Regardless of exactly how the candidate information is received, the information for the candidate 345 can be validated, e.g., by validation module 335, against the service provider records 325 based on the identifier definitions 330. That is, the candidate information 345 indicated by the identifier definitions 330 can then be used to search against the service providers records 325. When a potential match is recognized based on the defined identifiers 330 and maintained service provider information 325, a warning can be issued by the validation module 335 and the user, e.g., coordinator or administrator, given an opportunity to determine whether it is an actual match or not and/or update the service provider information, e.g., provide an indication of eligibility or ineligibility. For example, the validation module 335 can provide user interfaces such as illustrated and described in detail below with reference to FIGS. 10-12 through which various warnings can be provided and updates can be received.

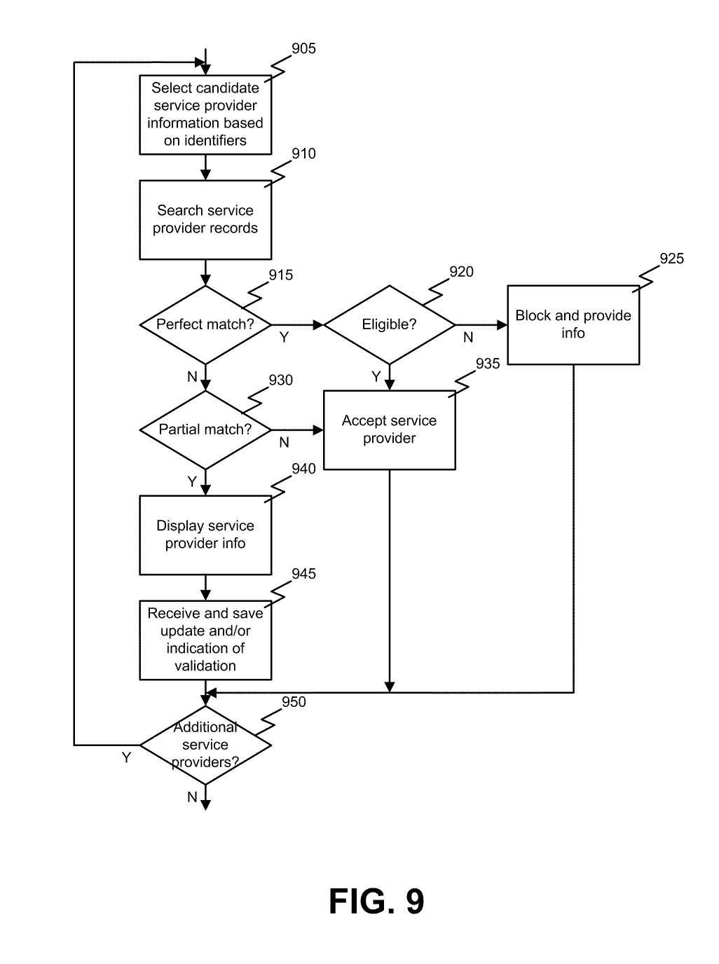

Stated another way, a system 300 according to one embodiment can comprise a repository of service provider identifiers 330 having stored therein a set of identifiers for information related to a plurality of service providers and a repository of service provider information 325 having stored therein a set of records of service provider information. Each record of the set of records of service provider information 325 can include information corresponding to the set of identifiers 330. The system 300 can also include a Supplier Relationship Management (SRM) system 305 communicatively coupled with the repository of service provider identifiers 330 and the repository of service provider information 325. The SRM system 305 can receive information 345 for a candidate service provider and validate the received information 345 for the candidate service provider based on the set of identifiers 330 and the set of records of service provider information 325 to determine whether the candidate service provider is eligible for a new assignment. Validating the received information 345 for the candidate service provider can comprise selecting information from the received information 345 for the candidate service provider based on the set of identifiers 330 and searching the set of records of service provider information 325 for information matching the selected information from the received information 345 for the candidate service provider. An exemplary process for validating the candidate service provider will be described in greater detail below with reference to FIG. 9.

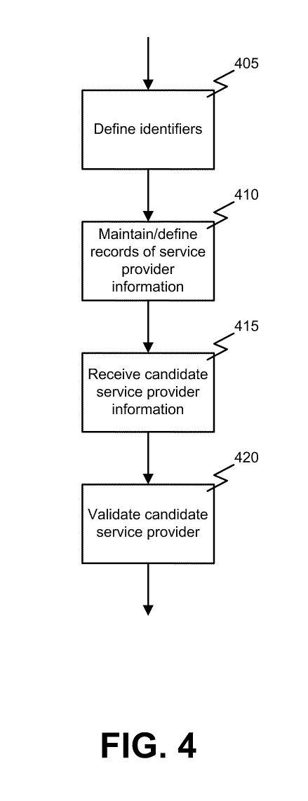

FIG. 4 is a flowchart illustrating a process for maintaining service provider information and determining service provider eligibility according to one embodiment of the present invention. In this example, determining eligibility of a candidate service provider for a new assignment can begin with defining 405 a set of identifiers for information related to a plurality of service providers. As noted above, defining 405 a set of identifiers for information related to a plurality of service providers can be performed through a user interface such as illustrated in and described in detail below with reference to FIG. 5. Through this or another interface, a set of identifiers can be defined 405 which indicate which information related to the candidate service provider will be used to validate the candidate service provider.

A set of records of service provider information can be maintained 410 where each record of the set of records includes information corresponding to the set of identifiers. Additionally, each record of the set of records of service provider information can include a field for an indication of eligibility or ineligibility. As noted above, maintaining 410 a set of records of service provider information can be performed through a user interface such as illustrated and described in detail below with reference to FIGS. 6A and 6B. Through these or another user interface, service provider information records can be defined and/or edited.

Information for the candidate service provider can be received 415. Receiving 415 the information for the candidate service provider can comprise receiving the information for the candidate service provider via a bidding process via a work order process. As noted above, a bidding process can provide a user interface such as illustrated in and described in detail below with reference to FIGS. 7A and 7B through which candidate information can be submitted. Additionally or alternatively, a work order process can provide a user interface such as illustrated in and described in detail below with reference to FIG. 8 through which candidate information can be submitted.

Regardless of exactly how the candidate information is received 415, the information for the candidate service provider can be validated 420 based on the set of identifiers and the set of records of service provider information to determine whether the candidate service provider is eligible for the new assignment. An exemplary process for validating 420 the candidate service provider will be described in greater detail below with reference to FIG. 9.

As noted above, various different user interfaces can be used through which identifier definitions can be made, records of service provider information can be maintained, candidate service provider information can be entered, warnings of matches or potential matches can be made, and updates of service provider information can be received. The following description of exemplary user interfaces is provided for illustrative purposes only and are not intended to limit the scope of the present invention. It should be understood that various other graphical and non-graphical user interfaces with various other formats, content, etc. can be implemented. Furthermore, these variations are not considered to be mutually exclusive. Rather, various different interfaces can be used in combination to be displayed individually upon selection or request by the user and/or displayed together, side-by-side, overlaid, or with another arrangement. These variations are contemplated and considered to be within the scope of the present invention.

FIG. 5 is a screenshot illustrating an exemplary user interface for service provider identifier definition according to one embodiment of the present invention. This example illustrates a page 500 such as a webpage or other interface through which a user, e.g., an administrator or coordinator, can define service provider identifiers. The identifiers defined here can be stored and used to validate candidate information as described above. Through this page 500 an administrator, coordinator, or other user can add and/or change the values of each identifier. As illustrated in this example, the page can include text boxes, dialog boxes, check boxes and/or other elements 505-525 for setting the identifier definitions. The exemplary elements illustrated here include but are not limited to: An Identifier (ID) textbox 505 through which a code to uniquely name the identifier can be set; A Description textbox 510 through which a short description of the identifier can be set; A Long Description textbox 510 through which a longer description of the identifier can be set; A Hide Fields Check box 520 which can be used to determine whether or not to show this identifier's values when displaying the list of potential matches, e.g., when the box is selected, the identifier's value will be hidden on the potential matches page; and A Country Code dialog box 525 through which a country is specified where this identifier will be used. Country code can be considered an optional field, e.g., if specified the identifier will only be available for use with those countries listed but if left blank, the identifier can be used for any country.

FIGS. 6A and 6B are screenshots illustrating exemplary user interfaces for service provider information maintenance according to one embodiment of the present invention. This example illustrates a page 600 such as a webpage or other interface through which a user, e.g., an administrator or coordinator, can view and/or edit information from a record for a service provider. For example, the page can include one or more textboxes 605-615 for editing a name, status, and title of the service provider. The page can include a checkbox 620 for use by the administrator or other user to specify whether a service provider is eligible for new assignments. If an administrator deems that a service provider is not eligible or that a provider has become eligible again (i.e. from previously being specified as not eligible status), the checkbox can be selected or unselected accordingly.

Additionally, a grid or dialog box 625 can be provided for defining the identification information, which can then be used to determine potential matches. Administrators can set up any number of identifiers for a service provider, which can be used to match against in the bidding process and manual work order creation. Any potential matches found can be flagged during the bidding or work order process. The dialog box 625 can include, for example, a textbox 626 for editing country data for the service provider. As noted above, country can be considered an optional parameter. Country codes can be used in combination with identifiers to specify values that will uniquely identify a service provider. When a country code is selected, only those identifiers associated specifically to that country, or identifiers with no associated country will be available for selection. For example, social security number might only be available when USA is selected as the country, but passport number might be available for any selected country. The dialog box 625 can also include a combobox 627 for editing an identifier (ID) that can contain a drop down list of the identifiers previously defined for the specified country (or those not associated to any country) on the service provider identifiers page. The value textbox 628 can be used to specify an alphanumeric value for the specified country and identifier, which can then be used to identify the provider and aid in searches for any potential matches to ineligible service providers. According to one embodiment, the page 600 can also include an eligibility history link 629. This link 629 can navigate the user to a new history page 630 as illustrated by FIG. 6B showing a list 635 of changes that have been made to eligibility status for this service provider.

FIGS. 7A and 7B are screenshots illustrating exemplary user interfaces for submitting service provider information under a bidding process according to one embodiment of the present invention. This example illustrates a page 700 such as a webpage or other interface through which a user, e.g., an administrator or coordinator, can submit or create a candidate service provider. For example, the page 700 can include but is not limited to a text box 705 for entering information, e.g., a name, identification number, or other indicator, identifying a service provider previously entered and known to the system. Additionally, the page 700 can include a button 706, link, or other element for creating a new candidate. Manipulation of, e.g., clicking or otherwise selecting, this element can cause a new page 710 to be displayed as illustrated by FIG. 7B. This page 710 can provide a number of elements 715-730 for entering information, e.g., name text boxes 715 and 716, email address text box 720, provider competencies dialog box 725, eligibility information dialog box 730, etc., related to the new candidate service provider.

FIG. 8 is a screenshot illustrating an exemplary user interface for submitting service provider information under a work order process according to one embodiment of the present invention. This example illustrates a page 800 such as a webpage or other interface through which a user, e.g., an administrator or coordinator, can submit a work order for a project. For example, the page 800 can include but is not limited to text boxes 805 and 810 for entering project start and end dates, a text box 815 for entering the vendor or agency providing the candidate service provider, and a text box 820 for entering a name or other identifier for the candidate service provider.

FIG. 9 is a flowchart illustrating a process for validating service provider information according to one embodiment of the present invention. In this example, validating the received information for the candidate service provider can begin with selecting 905 information from the received information for the candidate service provider based on the set of identifiers. The set of records of service provider information can be searched 910 for information matching the selected information from the received information for the candidate service provider.

A determination 915 can be made as to whether a perfect match has been found between the selected information from the received information for the candidate service provider and a record of the set of records of service provider information. In response to determining 915 that a perfect match has been found between the selected information from the received information for the candidate service provider and a record of the set of records of service provider information, a determination 920 can be made as to whether the candidate service provider is eligible based on the indication of eligibility for the matching record. In response to determining 920 that the candidate service provider is eligible, the candidate service provider can be accepted 935 for the new assignment. In response to determining the candidate service provider is ineligible, the candidate service provider can be blocked from the new assignment and a warning or other information can be provided, for example through a user interface as illustrated in and described in detail below with reference to FIGS. 10A and/or 11A.

In response to determining 915 that a perfect match has not been found between the selected information from the received information for the candidate service provider and a record of the set of records of service provider information, a determination 930 can be made as to whether a partial match has been found between the selected information from the received information for the candidate service provider and a record of the set of records of service provider information. In response to determining that no partial match has been found between the selected information from the received information for the candidate service provider and a record of the set of records of service provider information, the candidate service provider can be accepted 935 for the new assignment.

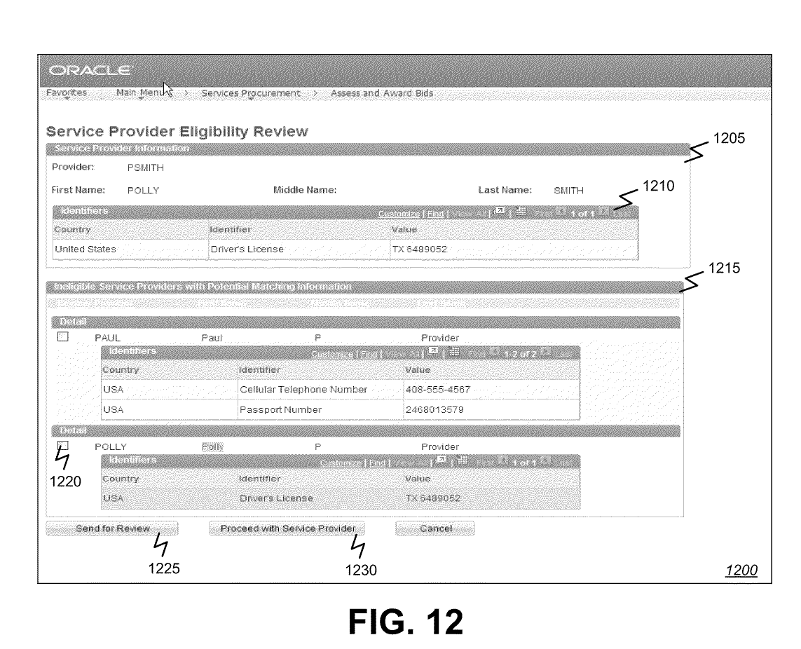

In response to finding a partial match between the selected information from the received information for the candidate service provider and a record of the set of records of service provider information, the service provider information from the matching record can be displayed 940, for example, through a user interface as illustrated in and described in detail below with reference to FIGS. 10B and/or 11B. An update of the service provider information for the received information for the candidate service provider can be received and saved 945. For example, the update of the service provider information for the received information for the candidate service provider can include an indication of eligibility or ineligibility. Updating the service provider information for the received information for the candidate service provider can be performed, for example, through a user interface as illustrated in and described in detail below with reference to FIG. 12.

A determination 950 can then be made as to whether additional candidate service provider information remains to be validated. In response to determining 950 additional candidate service provider information remains to be validated, processing can return to selecting 905 information from the received information for the next candidate service provider based on the set of identifiers. That is, validation can continue until each candidate has been validated or processing is otherwise stopped or suspended.

FIGS. 10A and 10B are screenshots illustrating exemplary user interfaces for providing validation warnings according to one embodiment of the present invention. These examples illustrates a page 1000 or 1010 such as a webpage or other interface through which a message 1005 or 1015 can be provided indicating a match or potential match of the candidate service provider information with information for an ineligible service provider. For example, when a service provider contact submits an existing service provider candidate who is flagged already in the system as not eligible, an error message 1005 can be shown to the coordinator as illustrated in FIG. 10A informing that the service provider candidate is not eligible and bid negotiations cannot continue for this individual. In this situation, the coordinator can decline the bid or end the communication.

In another example, when a service provider is not flagged as ineligible, but the search discovers potential matches to other ineligible service providers based on a comparison of name and identifier values for the candidate, a warning message 1015 can be displayed to the coordinator as illustrated in FIG. 10B. The coordinator can then review the information presented and determine whether there are actually matches to another candidate that has been identified as not eligible. This situation can occur both for new candidates created during the bid submittal process and for existing candidates that are currently marked as eligible or ineligible in the system. The warning message 1015 can direct the coordinator to check the search results, for example via a results page as illustrated in and described below with reference to FIG. 12. If, after reviewing the information, the coordinator thinks that the service provider on the bid matches with one of the candidates in the search results, an administrator can be notified to review and set the status as not eligible to flag the service provider candidate for future submittals. If, after reviewing the information, the coordinator does not think that there is truly a match, the bidding process can continue.

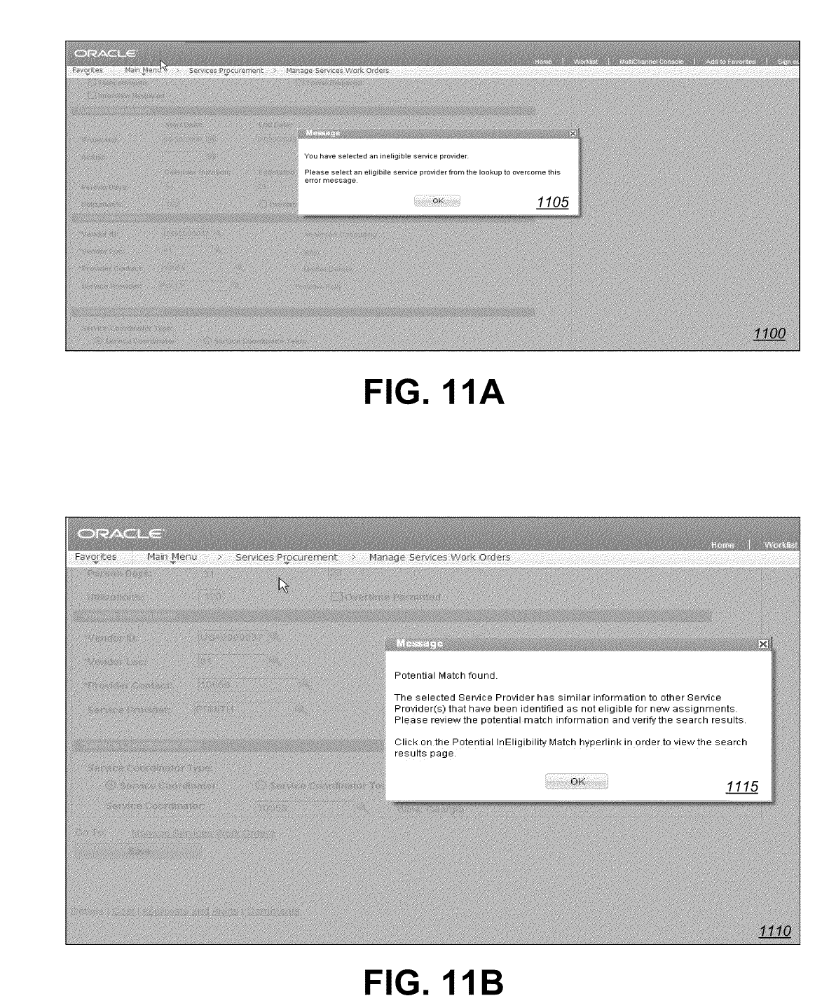

FIGS. 11A and 11B are screenshots illustrating exemplary user interfaces for providing validation warnings according to another embodiment of the present invention. These examples illustrates a page 1100 or 1110 such as a webpage or other interface through which a message 1105 or 1115 can be provided indicating a match or potential match of the candidate service provider information with information for an ineligible service provider. For example, selection of an existing ineligible service provider candidate can be prevented when creating a manual work order or manually replacing a service provider on an existing work order. When a requestor or coordinator is entering a manual work order and a service provider candidate is selected that has been flagged as ‘Ineligible’ in the system, an error message 1105 can be displayed. According to one embodiment, the work order with this service provider candidate selected will not be saved.

In another example, when creating a manual work order or replacing the service provider candidate on an existing work order, a warning message 1115 can be displayed if any potential matches are found. When a requestor or coordinator is entering a manual work order, if a potential match is found in the system between one or more existing service providers who have an eligibility status of ineligible and the service provider candidate on the work order, a warning message 1115 will be displayed and a page such as illustrated in an described below with reference to FIG. 12 can be provided to view the results.

FIG. 12 is a screenshot illustrating an exemplary user interface for reviewing service provider information according to one embodiment of the present invention. This example illustrates a page 1200 such as a webpage or other interface through which a user, e.g., an administrator or coordinator, can review information about potential matches between the service provider candidate being considered and existing service providers that have been marked as not eligible. For example, page can include a box 1205 in which the identifiers 1210 and other information for the candidate can be displayed for reference. The page 1200 can also include a list 1215 including information from any ineligible service providers discovered as potential matches. If a service provider on the list 1215 is determined to be an actual match, the coordinator can select the check box 1220 next to that service provider and click the ‘Send for Review’ push button 1225. This action can initiate a notification to the administrator or other entity to take further action on the service provider candidate from this bid to validate and potentially flag as ineligible in the system. If the coordinator does not think that there are actual matches in the list 1215 to the candidate submitted on the bid, the ‘Proceed with Service Provider’ button 1230 can be clicked to continue on with the bid negotiation process.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for determining eligibility of a candidate service provider for a new assignment, the method comprising:
defining with a Supplier Relationship Management (SRM) system a set of identifiers for information related to a plurality of service providers;
maintaining with the SRM system a set of records of service provider information, each record of the set of records including information corresponding to the set of identifiers;
receiving at the SRM system information for the candidate service provider; and
validating with the SRM system the received information for the candidate service provider based on the set of identifiers and the set of records of service provider information to determine whether the candidate service provider is eligible for the new assignment.

2. The method of claim 1, wherein each record of the set of records of service provider information includes a field for an indication of eligibility.

3. The method of claim 1, wherein receiving the information for the candidate service provider comprises receiving the information for the candidate service provider via a bidding process.

4. The method of claim 1, wherein receiving the information for the candidate service provider comprises receiving the information for the candidate service provider via a work order process.

5. The method of claim 2, wherein validating the received information for the candidate service provider comprises:
selecting information from the received information for the candidate service provider based on the set of identifiers; and
searching the set of records of service provider information for information matching the selected information from the received information for the candidate service provider.

6. The method of claim 5, further comprising, in response to finding a perfect match between the selected information from the received information for the candidate service provider and a record of the set of records of service provider information, determining with the SRM system whether the candidate service provider is eligible based on the indication of eligibility for the matching record.

7. The method of claim 6, further comprising, in response to determining the candidate service provider is ineligible, blocking the candidate service provider from the new assignment with the SRM system.

8. The method of claim 5, further comprising, in response to finding a partial match between the selected information from the received information for the candidate service provider and a record of the set of records of service provider information, displaying the service provider information from the matching record with the SRM system.

9. The method of claim 8, further comprising receiving at the SRM system an update of the service provider information for the received information for the candidate service provider, and saving the update of the service provider information for the received information for the candidate service provider.

10. The method of claim 9, wherein the update of the service provider information for the matching record includes an indication of eligibility.

11. A system comprising:
a repository of service provider identifiers having stored therein a set of identifiers for information related to a plurality of service providers;
a repository of service provider information having stored therein a set of records of service provider information, each record of the set of records including information corresponding to the set of identifiers;
a Supplier Relationship Management (SRM) system communicatively coupled with the repository of service provider identifiers and the repository of service provider information, wherein the SRM system receives information for a candidate service provider and validates the received information for the candidate service provider based on the set of identifiers and the set of records of service provider information to determine whether the candidate service provider is eligible for a new assignment.

12. The system of claim 11, wherein validating the received information for the candidate service provider comprises:
selecting information from the received information for the candidate service provider based on the set of identifiers; and
searching the set of records of service provider information for information matching the selected information from the received information for the candidate service provider.

13. The system of claim 12, wherein the SRM system, in response to finding a perfect match between the selected information from the received information for the candidate service provider and a record of the set of records of service provider information, determines whether the candidate service provider is eligible based on an indication of eligibility from the matching record.

14. The system of claim 12, wherein the SRM system, in response to finding a partial match between the selected information from the received information for the candidate service provider and a record of the set of records of service provider information, displays the service provider information from the matching record.

15. The system of claim 14, wherein the SRM system further receives an update of the service provider information for the received information for the candidate service provider and saves the update of the service provider information for the received information for the candidate service provider.

16. The system of claim 15, wherein the update of the service provider information for the matching record includes an indication of eligibility.

17. A machine-readable medium having stored therein a series of executable instructions which, when executed by a processor, cause the processor to determine eligibility of a candidate service provider for a new assignment by:
defining with a Supplier Relationship Management (SRM) system a set of identifiers for information related to a plurality of service providers;
maintaining with the SRM system a set of records of service provider information, each record of the set of records including information corresponding to the set of identifiers;
receiving at the SRM system information for the candidate service provider; and
validating with the SRM system the received information for the candidate service provider based on the set of identifiers and the set of records of service provider information to determine whether the candidate service provider is eligible for the new assignment.

18. The machine-readable medium of claim 17, wherein each record of the set of records of service provider information includes a field for an indication of eligibility.

19. The machine-readable medium of claim 17, wherein receiving the information for the candidate service provider comprises receiving the information for the candidate service provider via a bidding process.

20. The machine-readable medium of claim 17, wherein receiving the information for the candidate service provider comprises receiving the information for the candidate service provider via a work order process.

21. The machine-readable medium of claim 18, wherein validating the received information for the candidate service provider comprises:
selecting information from the received information for the candidate service provider based on the set of identifiers; and
searching the set of records of service provider information for information matching the selected information from the received information for the candidate service provider.

22. The machine-readable medium of claim 21, further comprising, in response to finding a perfect match between the selected information from the received information for the candidate service provider and a record of the set of records of service provider information, determining with the SRM system whether the candidate service provider is eligible based on the indication of eligibility for the matching record.

23. The machine-readable medium of claim 22, further comprising, in response to determining the candidate service provider is ineligible, blocking the candidate service provider from the new assignment with the SRM system.

24. The machine-readable medium of claim 21, further comprising, in response to finding a partial match between the selected information from the received information for the candidate service provider and a record of the set of records of service provider information, displaying the service provider information from the matching record with the SRM system.

25. The machine-readable medium of claim 24, further comprising receiving at the SRM system an update of the service provider information for the received information for the candidate service provider, and saving the update of the service provider information for the received information for the candidate service provider.
